(19) United States
(12) Patent Application Publication
(10) Pub. No.: US 2014/0063017 A1
(43) Pub. Date: Mar. 6, 2014

(54) Method and System of Model Shading and Reduction of Vertices for 3D Imaging on a Clinician Programmer

(71) Applicant: Greatbatch Ltd., Clarence, NY (US)

(72) Inventors: Norbert Kaula, Arvada, CO (US); Yohannes Iyassu, Denver, CO (US)

(73) Assignee: Greatbatch Ltd., Clarence, NY (US)

(21) Appl. No.: 14/010,872

(22) Filed: Aug. 27, 2013

Related U.S. Application Data
(63) Continuation-in-part of application No. 13/601,449, filed on Aug. 31, 2012.
(60) Provisional application No. 61/824,296, filed on May 16, 2013.
(60) Provisional application No. 61/695,676, filed on Aug. 31, 2012.
(60) Provisional application No. 61/695,721, filed on Aug. 31, 2012.
(60) Provisional application No. 61/695,407, filed on Aug. 31, 2012.
(60) Provisional application No. 61/695,413, filed on Aug. 31, 2012.

(51) Int. Cl. G06T 15/80

(52) U.S. Cl. CPC G06T 15/80
USPC 345/426

(57) ABSTRACT

The present disclosure involves a method of providing three-dimensional imaging in a medical environment. A first three-dimensional (3D) model is provided. The first 3D model represents a part of human anatomy or an implantable medical device. The first 3D model contains a plurality of vertices. A second 3D model is then generated by performing a vertex-reduction process to the first 3D model. The second 3D model has fewer vertices than the first 3D model. A shading texture is applied to the second 3D model to obtain a texture-shaded second 3D model. The applying the shading texture is performed using the first 3D model as a reference so that the texture-shaded second 3D model resembles the first 3D model.

### PRIORITY DATA

The present application is a utility application of provisional U.S. Patent Application No. 61/695,413, filed on Aug. 31, 2012, entitled “Method and System of Model Shading and Reduction of Vertices for 3D Imaging on a Clinician Programmer,” and a utility application of provisional U.S. Patent Application No. 61/695,407, filed on Aug. 31, 2012, entitled “Method and System of Producing 2D Representations of 3D Pain and Stimulation Maps and Implant Models on a Clinician Programmer,” and a utility application of provisional U.S. Patent Application No. 61/695,721, filed on Aug. 31, 2012, entitled “Method and System of Creating, Displaying, and Comparing Pain and Stimulation Maps,” and a utility application of provisional U.S. Patent Application No. 61/695,676, filed on Aug. 31, 2012, entitled “Method and System of Adjusting 3D Models of Patients on a Clinician Programmer,” and a utility application of provisional U.S. Patent Application No. 61/824,296, filed on May 16, 2013, entitled “Features and Functionalities of an Advanced Clinician Programmer,” and a continuation-in-part of U.S. patent application Ser. No. 13/601,449, filed on Aug. 31, 2012, entitled “Virtual Reality Representation of Medical Devices”, the disclosures of each of which is hereby incorporated by reference in their entirety.

### BACKGROUND

As medical device technologies continue to evolve, active implanted medical devices have gained increasing popularity in the medical field. For example, one type of implanted medical device includes neurostimulator devices, which are battery-powered or battery-less devices that are designed to deliver electrical stimulation to a patient. Through proper electrical stimulation, the neurostimulator devices can provide pain relief for patients or restore bodily functions.

Implanted medical devices (for example a neurostimulator) can be controlled using an electronic programming device such as a clinician programmer or a patient programmer. These programmers can be used by medical personnel or the patient to define the particular electrical stimulation therapy to be delivered to a target area of the patient's body, alter one or more parameters of the electrical stimulation therapy, or otherwise conduct communications with a patient. Advances in the medical device field have improved these electronic programmers. For example, some existing programmers allow models of human anatomy or medical devices to be displayed and manipulated as a part of the medical diagnosis and communication with the patient. However, the display and manipulation of these models on existing programmers have certain shortcomings. For example, it may be difficult to display or manipulate these models in a three-dimensional (3D) environment due to a high number of vertices required for conventional 3D modeling. Portable electronic devices such as the clinician programmer generally are not equipped with the processing power to handle data-intensive tasks associated with the high number of vertices in 3D models. As a result, conventional programmers rely on 2D models, or have to settle for 3D models that are slow and laggy, thereby leading to a frustrating user experience.

Therefore, although existing methods and mechanisms for displaying and manipulating models in a medical environment have been generally adequate for their intended purposes, they have not been entirely satisfactory in every aspect.

### SUMMARY

One aspect of the present disclosure involves an electronic device for providing a three-dimensional imaging in a medical environment. The electronic device includes: a memory storage component configured to store programming code; and a computer processor configured to execute the programming code to perform the following tasks: providing a first three-dimensional (3D) model that represents a part of human anatomy or an implantable medical device, wherein the first 3D model contains a plurality of vertices; generating a second 3D model by performing a vertex-reduction process to the first 3D model, the second 3D model having fewer vertices than the first 3D model; and applying a shading texture to the second 3D model to obtain a texture-shaded second 3D model, wherein the applying the shading texture is performed using the first 3D model as a reference so that the texture-shaded second 3D model resembles the first 3D model.

Another aspect of the present disclosure involves a medical system. The medical system includes: one or more medical devices configurable to deliver a medical therapy to a patient; and an electronic device configured to provide a three-dimensional (3D) imaging in a medical environment via a touch-sensitive visual user interface, wherein the electronic device includes a non-transitory computer readable medium comprising executable instructions that when executed by a processor, causes the processor to perform the steps of: providing a first three-dimensional (3D) model that represents a part of human anatomy or an implantable medical device, wherein the first 3D model contains a plurality of vertices; generating a second 3D model by performing a vertex-reduction process to the first 3D model, the second 3D model having fewer vertices than the first 3D model; and applying a shading texture to the second 3D model to obtain a texture-shaded second 3D model, wherein the applying the shading texture is performed using the first 3D model as a reference so that the texture-shaded second 3D model resembles the first 3D model.

Yet another aspect of the present disclosure involves method of providing a three-dimensional imaging in a medical environment. The method includes: providing a first three-dimensional (3D) model that represents a part of human anatomy or an implantable medical device, wherein the first 3D model contains a plurality of vertices; generating a second 3D model by performing a vertex-reduction process to the first 3D model, the second 3D model having fewer vertices than the first 3D model; and applying a shading texture to the second 3D model to obtain a texture-shaded second 3D model, wherein the applying the shading texture is performed using the first 3D model as a reference so that the texture-shaded second 3D model resembles the first 3D model.

One more aspect of the present disclosure involves a non-transitory computer readable medium. The non-transitory computer readable medium comprises executable instructions that when executed by a processor, causes the processor to perform the steps of: providing a first three-dimensional (3D) model that represents a part of human anatomy or an implantable medical device, wherein the first 3D model contains a plurality of vertices; generating a second 3D model by performing a vertex-reduction process to the first 3D model, the second 3D model having fewer vertices than the first 3D model; and applying a shading texture to the second 3D model to obtain a texture-shaded second 3D model, wherein the applying the shading texture is performed using the first 3D model as a reference so that the texture-shaded second 3D model resembles the first 3D model.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designation have the same or similar functions.

FIG. 1 is a simplified block diagram of an example medical environment in which evaluations of a patient may be conducted according to various aspects of the present disclosure.

FIGS. 2A-4A and 2B-4B are graphical illustrations of various techniques of vertex reduction for a 3D model according to various aspects of the present disclosure.

FIG. 5 is an example illustration of a shading texture according to various aspects of the present disclosure.

FIGS. 6-8 are example graphical user interfaces illustrating the use and application of vertex-reduced 3D models according to various aspects of the present disclosure.

FIG. 9 is a flowchart illustrating a method of providing 3D imaging in a medical environment according to various aspects of the present disclosure.

FIG. 10 is a simplified block diagram of an electronic programmer according to various aspects of the present disclosure.

FIG. 11 is a simplified block diagram of an implantable medical device according to various aspects of the present disclosure.

FIG. 12 is a simplified block diagram of a medical system/infrastructure according to various aspects of the present disclosure.

FIGS. 13A and 13B are side and posterior views of a human spine, respectively.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. Various features may be arbitrarily drawn in different scales for simplicity and clarity.

The use of active implanted medical devices has become increasingly prevalent over time. Some of these implanted medical devices include neurostimulator devices that are capable of providing pain relief by delivering electrical stimulation to a patient. In that regards, electronic programmers have been used to configure or program these neurostimulators (or other types of suitable active implanted medical devices) so that they can be operated in a certain manner. These electronic programmers include clinician programmers and patient programmers, each of which may be a handheld device. For example, a clinician programmer allows a medical professional (e.g., a doctor or a nurse) to define the particular electrical stimulation therapy to be delivered to a target area of the patient's body, while a patient programmer allows a patient to alter one or more parameters of the electrical stimulation therapy.

In recent years, these electronic programmers have achieved significant improvements, for example, improvements in size, power consumption, lifetime, and ease of use. For instance, electronic programmers have been used to provide more realistic visualization of a human anatomical environment in order to achieve better diagnosis for the patient. As an example of the visualization may include computerized pain maps and stimulation maps (collectively referred to as a sensation map) for a patient. In general, a pain map shows the location or intensity of a patient's pain, and a stimulation map shows the location or intensity of the electrical stimulation (e.g., stimulation delivered by the neurostimulator) perceived by the patient. These sensation maps can serve as useful tools for diagnosing the patient's pain and also allow visual/non-verbal communication between a patient and a healthcare professional. In addition, a history of the maps, if collected, can provide a record of a patient's treatment progress, and the maps can also be analyzed across patient groups.

Nevertheless, existing methods for providing realistic visualization still have drawbacks. For instance, realistic visualization may require a three-dimensional (3D) human body model represented by a high number of vertices, which are coordinates of polygons or polyhedrons that determine how the model is shaped. As an example, a cube contains eight vertices, one located at each corner. A typical 3D anatomical environment (e.g. the 3D models of spines, implanted medical devices, or other body tissue) contains too many vertices for feasible 3D model processing on existing clinician programmers, as the clinician programmers are usually not equipped with enough processing power to handle data-intensive processing tasks associated with the high number of vertices. As a result, the display or manipulation of conventional 3D models on existing programmers tend to be slow and laggy, sometimes to the point where they become practically unusable, thereby leading to user frustration or errors.

To avoid the problems associated with conventional 3D modeling, many manufacturers for the electronic programmers have opted to not implement 3D modeling on the programmers at all, instead going with less data-intensive 2D models without real-time rendering to allow user selected viewing angles of the model. Unfortunately, such 2D models are not intuitive to the user and are less versatile or realistic in providing a visualization in a medical context, which again may lead to user dissatisfaction or errors.

To overcome these problems discussed above, the present disclosure offers a method and apparatus for generating and displaying less data-intensive 3D models (e.g., models of human anatomy or medical devices) on an electronic programmer. According to the various aspects of the present disclosure, these less data-intensive 3D models may be obtained through a reduction of vertices (also referred to as vertex reduction). In other words, the high number of vertices in a conventional 3D model may be greatly reduced to facilitate faster data processing without sacrificing the overall 3D-likeness of such models, which will now be discussed below in more detail.

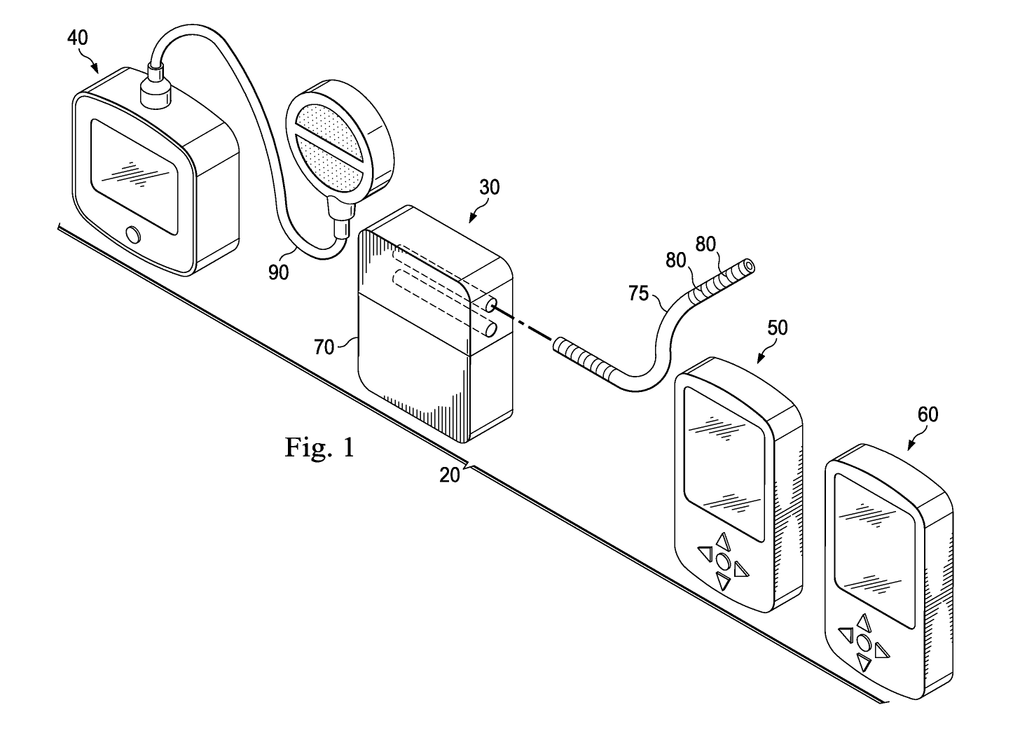

FIG. 1 is a simplified block diagram of a medical device system 20 is illustrated to provide an example context of the various aspects of the present disclosure. The medical system 20 includes an implantable medical device 30, an external charger 40, a patient programmer 50, and a clinician programmer 60. The implantable medical device 30 can be implanted in a patient's body tissue. In the illustrated embodiment, the implantable medical device 30 includes an implanted pulse generator (IPG) 70 that is coupled to one end of an implanted lead 75. The other end of the implanted lead 75 includes multiple electrode surfaces 80 through which electrical current is applied to a desired part of a body tissue of a patient. The implanted lead 75 incorporates electrical conductors to provide a path for that current to travel to the body tissue from the IPG 70. Although only one implanted lead 75 is shown in FIG. 1, it is understood that a plurality of implanted leads may be attached to the IPG 70.

Although an IPG is used here as an example, it is understood that the various aspects of the present disclosure apply to an external pulse generator (EPG) as well. An EPG is intended to be worn externally to the patient's body. The EPG connects to one end (referred to as a connection end) of one or more percutaneous, or skin-penetrating, leads. The other end (referred to as a stimulating end) of the percutaneous lead is implanted within the body and incorporates multiple electrode surfaces analogous in function and use to those of an implanted lead.

The external charger 40 of the medical device system 20 provides electrical power to the IPG 70. The electrical power may be delivered through a charging coil 90. In some embodiments, the charging coil can also be an internal component of the external charger 40. The IPG 70 may also incorporate power-storage components such as a battery or capacitor so that it may be powered independently of the external charger 40 for a period of time, for example from a day to a month, depending on the power requirements of the therapeutic electrical stimulation delivered by the IPG.

The patient programmer 50 and the clinician programmer 60 may be portable handheld devices that can be used to configure the IPG 70 so that the IPG 70 can operate in a certain way. The patient programmer 50 is used by the patient in whom the IPG 70 is implanted. The patient may adjust the parameters of the stimulation, such as by selecting a program, changing its amplitude, frequency, and other parameters, and by turning stimulation on and off. The clinician programmer 60 is used by a medical personnel to configure the other system components and to adjust stimulation parameters that the patient is not permitted to control, such as by setting up stimulation programs among which the patient may choose, selecting the active set of electrode surfaces in a given program, and by setting upper and lower limits for the patient's adjustments of amplitude, frequency, and other parameters.

In the embodiments discussed below, the clinician programmer 60 is used as an example of the electronic programmer. However, it is understood that the electronic programmer may also be the patient programmer 50 or other touch screen programming devices (such as smart-phones or tablet computers) in other embodiments.

As discussed above, existing 3D models contain a high number of vertices and therefore are quite data-intensive. Consequently, the display and interaction with 3D models are not easily implemented on existing clinician programmers, as they are often slow and laggy. According to the various aspects of the present disclosure, the clinician programmer 60 is used to generate and display vertex-reduced 3D models. These vertex-reduced 3D models allow for real-time or near real-time rendering and manipulation thereof. In certain embodiments, real-time computing is a sequence of instructions (issued by a user or a system) that are acted upon and updated within strict time constraints. In a user interface, a system that achieves a user action and/or updates at 10 or more frames per second may be considered to be real-time. For actions that take less then 10 frames to complete, the user can be updated with the progress of the action by interpolating the ‘display’ based on the known previous and next states. Several example techniques of vertex reduction are discussed in more detail below.

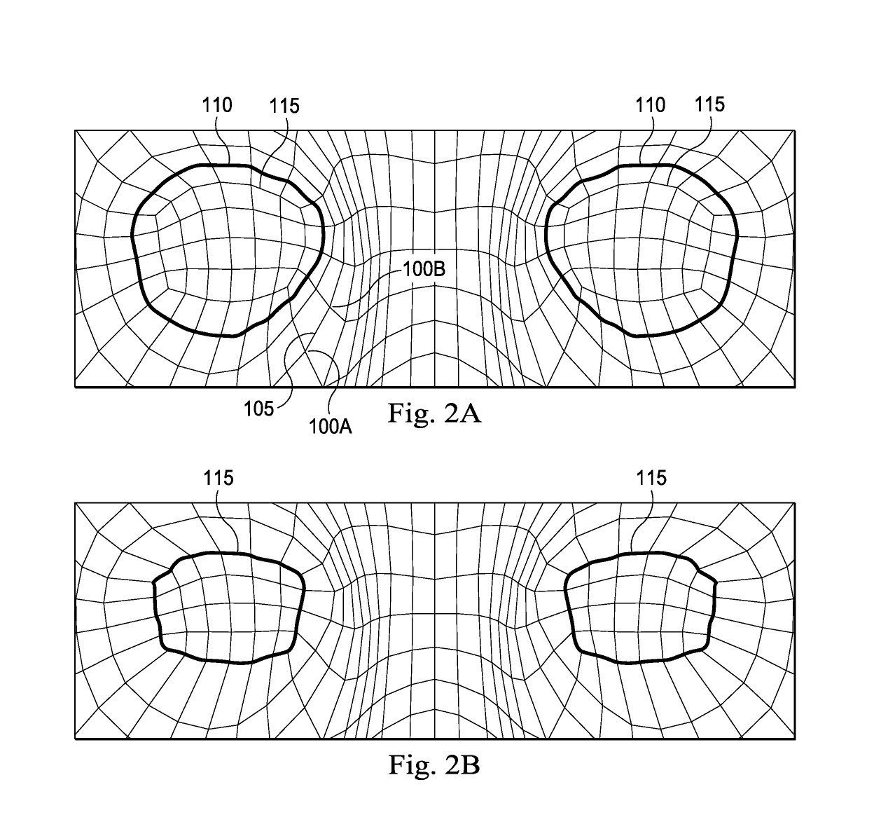

FIGS. 2A-2B illustrate an “edge sliding” technique of vertex reduction. In more detail, FIG. 2A illustrates a magnified frontal view of a pair of human eyes as an example of a 3D model before vertex-reduction, and FIG. 2B illustrates the magnified frontal view of the same pair of human eyes as an example of the 3D model after vertex reduction. The 3D model is defined by a plurality of vertices and edges that interconnect adjacent vertices. For example, two adjacent vertices 100A and 100B are interconnected by an edge 105. A plurality of edges may form a contour, for example a contour 110 in FIG. 2A or a contour 115 in FIG. 2B, which have been highlighted.

According to the various aspects of the present disclosure, when contours that are proximate to one another are topographically similar, one of these contours is merged to the other contour. The merging of the contours is feasible since it would not lead to a noticeably different shape for the 3D model. As an example, the “outer” contour 110 in FIG. 2A is topographically similar to the “inner” contour 115 that is immediately adjacent to, and surrounded by, the contour 110. Therefore, the “outer” contour 110 is merged into the “inner” contour 115. In other words, the outer contour 110 is eliminated as a part of the vertex reduction process, and the vertex-reduced 3D model shown in FIG. 2B is free of the outer contour 110. The overall shape of the vertex-reduced 3D model shown in FIG. 2B is still substantially similar to the original 3D model (i.e., without vertex reduction) shown in FIG. 2A.

The above example shows how an outer contour such as the contour 110 can be merged into the inner contour 115 if they are topographically similar. It is understood, however, that the inner contour 115 can be merged into the outer contour 110 in other embodiments. Also, if more than two immediately-adjacent contours are topographically similar, then all of these topographically-similar contours can be merged as well.

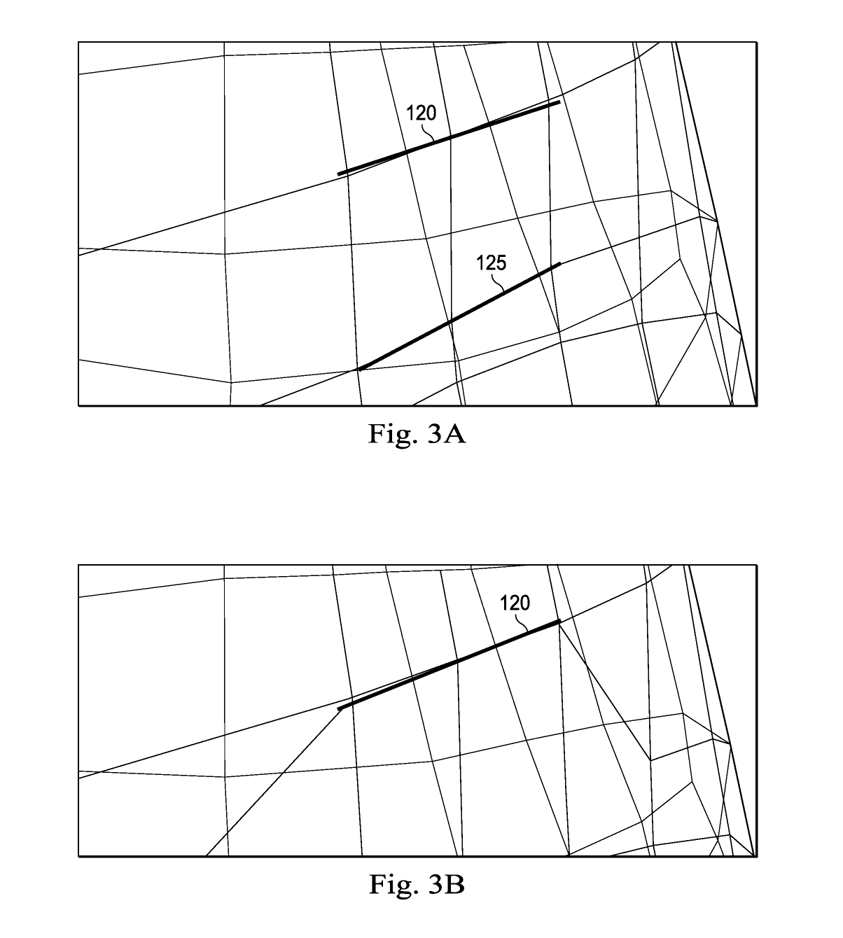

The contour-merging example discussed above and shown in FIGS. 2A-2B is merely one embodiment of the “edge sliding” technique, and it uses enclosed loops (since contours are considered enclosed loops). FIGS. 3A-3B illustrate another embodiment of the “edge sliding” technique using open loops. Referring to FIG. 3A, an original (unreduced) 3D model is illustrated, which contains an edge 120 and an edge 125. These edges 120-125 are topographically similar, but they need not be enclosed or contain the same number of vertices (e.g., one of them can contain two vertices while the other one contains three vertices). Therefore, according to the various aspects of the present disclosure, the edges 120 and 125 are merged together as shown in FIG. 3B. Again, the overall shape of the 3D model after applying the “open loop edge sliding” technique of vertex reduction remains substantially similar to the original 3D model before the vertex reduction process is performed.

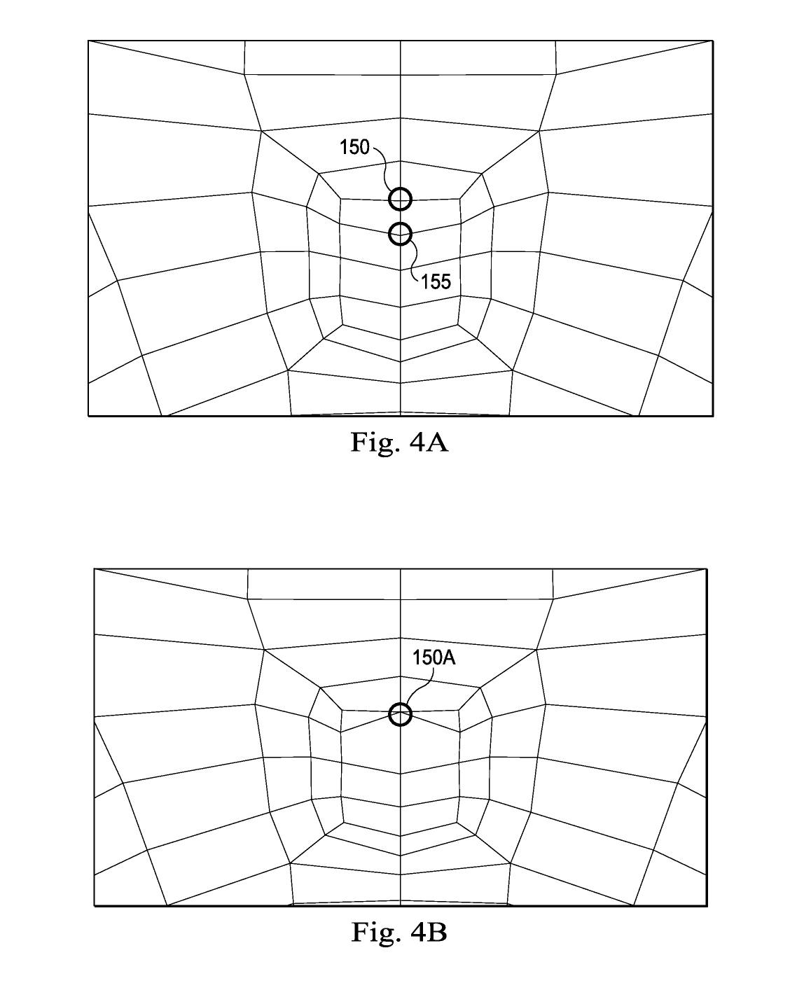

FIGS. 4A-4B illustrate a “vertex merging” technique as yet another embodiment of vertex reduction. Referring to FIG. 4A, an original (unreduced) 3D model is illustrated, which contains a vertex 150 and a vertex 155. However, the vertex 155 contributes little to no information to the overall shape and topography of the 3D model. In other words, the vertex 155 is mostly redundant. Therefore, according to the various aspects of the present disclosure, the vertices 150 and 155 are merged together as shown in FIG. 4B (the vertex 155 is merged into the vertex 150). Again, the overall shape of the 3D model after applying the “vertex merging” technique of vertex reduction remains substantially similar to the original 3D model before the vertex reduction process is performed.

In some embodiments, a computer module may be utilized to facilitate the vertex reduction process in each of the examples discussed above. For instance, a computer module may be used to determine what contours (closed loop) or edges (open loop) are considered topographically similar so that they can be merged, or what vertices are considered superfluous so that they can be eliminated or merged into other vertices, without drastically affecting the overall topography and shape of the 3D model. As an example, the various criteria for determining what is merge-able (e.g., minimum distance between two adjacent vertices, etc.) may be pre-programmed into the module. In other embodiments, a human user can also manually select contours/edges/vertices to be merged. Vertex reduction performed by a human user may be done instead of, or in addition to, the computer module.

By applying the various vertex reduction techniques discussed above, the high number of vertices in the original 3D model may be reduced to a more manageable number that is suitable for handling by processors on a clinician programmer. For example, in some embodiments, an original unreduced 3D model containing 15,000 to 20,000 vertices may be reduced to a model containing less than about 3,000 vertices by applying vertex reduction methods according to the various aspects of the present disclosure.

As discussed above, the vertex reduction process of the present disclosure is performed so that edges or vertices that do not contribute much information are eliminated or merged. However, the elimination of such a large number of edges or vertices throughout the 3D model may still cause the overall shape or topography of the 3D model to change. For example, in some cases, the vertex-reduced 3D model may have flatter topographies compared to its original 3D model, or does not look as “3D” as it is supposed to be. In other cases, the vertex-reduced 3D model may look crude or contain other inaccuracies, thereby adversely affecting the depiction of the 3D model it is intended to portray.

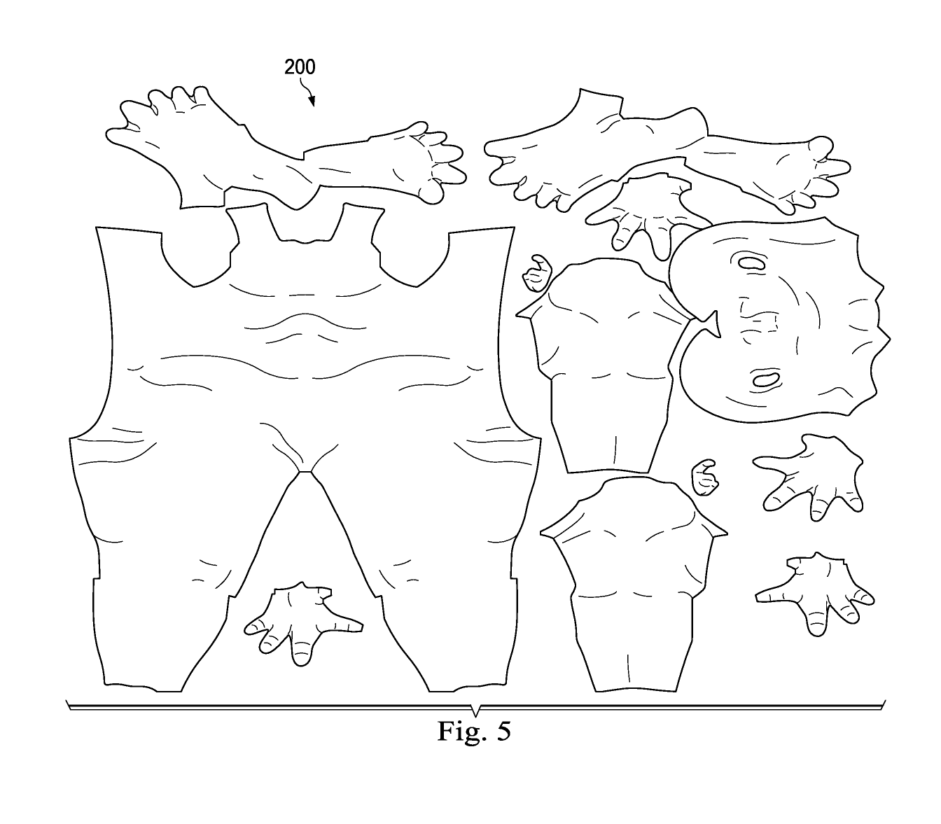

To rectify these issues, the present disclosure also performs a texture shading process to the vertex-reduced 3D model, so as to give the vertex-reduced 3D model the same (or substantially similar) appearance as the original 3D model. In some embodiments, “shading” relates to a process of applying color, textures, and finishes to meshes in order to simulate a wide variety of appearances, including patterns, actual painting and detailing, faces of people, and/or animals in a variety of settings. In some embodiments, “texture” or “textures” refer to one or more additional layers applied over (or on top) of the base layer or base material. Textures can affect one or more aspects of the object's net coloring. To illustrate, an example shading texture 200 (also referred to as a shading overlay) is shown in FIG. 5. In the illustrated embodiment, the shading texture 200 is a shading texture for a 3D model of a human body. The original 3D human body model is used to create the shading texture 200 for the vertex-reduced model that contains information about how light would bounce off the model were the original texturing still present. The shading texture 200 in this example is a 2D image and may be thought of as a “skin” that is taken off of the original 3D human body model. This 2D image contains colors or hues of different values, which are then used to create normal vectors of differing values. A normal vector is defined as a vector that points perpendicularly to a surface. According to the various aspects of the present disclosure, the shading texture 200 (i.e., the 2D image) is projected over and wrapped around the vertex-reduced 3D model. Thus, the normal vectors created by the different colors or hues in the shading texture 200 are defined as being perpendicular to the surface of the vertex-reduced 3D model. As such, the different vector values in turn gives the vertex-reduced 3D model the appearance (or illusion) of texture, even though the shading texture 200 is essentially a 2D image.

It is understood that the original 3D model may be used as a reference in either the generation of the shading texture 200, or the application of the shading texture 200 over the vertex-reduced 3D model, or both. Thus, by having the shading texture 200 applied thereto, the crude-looking vertex-reduced 3D model may resemble the original unreduced 3D model. Once the shading texture 200 has been generated and applied to the vertex-reduced 3D model, the original 3D model is no longer needed. Thereafter, the applications on the clinician programmer will use the vertex-reduced 3D model having the shading texture applied. The original 3D model need not be invoked except in the development of these applications.

By doing away with the original vertex-heavy 3D model and using the vertex-reduced 3D model (with the appropriate shading overlay), the 3D model processing in the applications running on the clinician programmer can be sped up significantly. This is because the vertex-reduced 3D model with the shading texture 200 demand much less processing power compared to the complex unreduced original 3D model, and therefore the graphical processing unit (GPU) on the clinician programmer can process the shading-texture-applied vertex-reduced 3D model in much less time than the original 3D model. For example, whereas a typical clinician programmer may be able to process the original 3D at a speed of about 15 frames per second, the same clinician programmer can process the vertex-reduced 3D model (after the application of the shading texture) at a speed of about 60 frames per second. The end result is a much smoother and lag-free user experience. Thus, user satisfaction is increased, and potential errors are reduced.

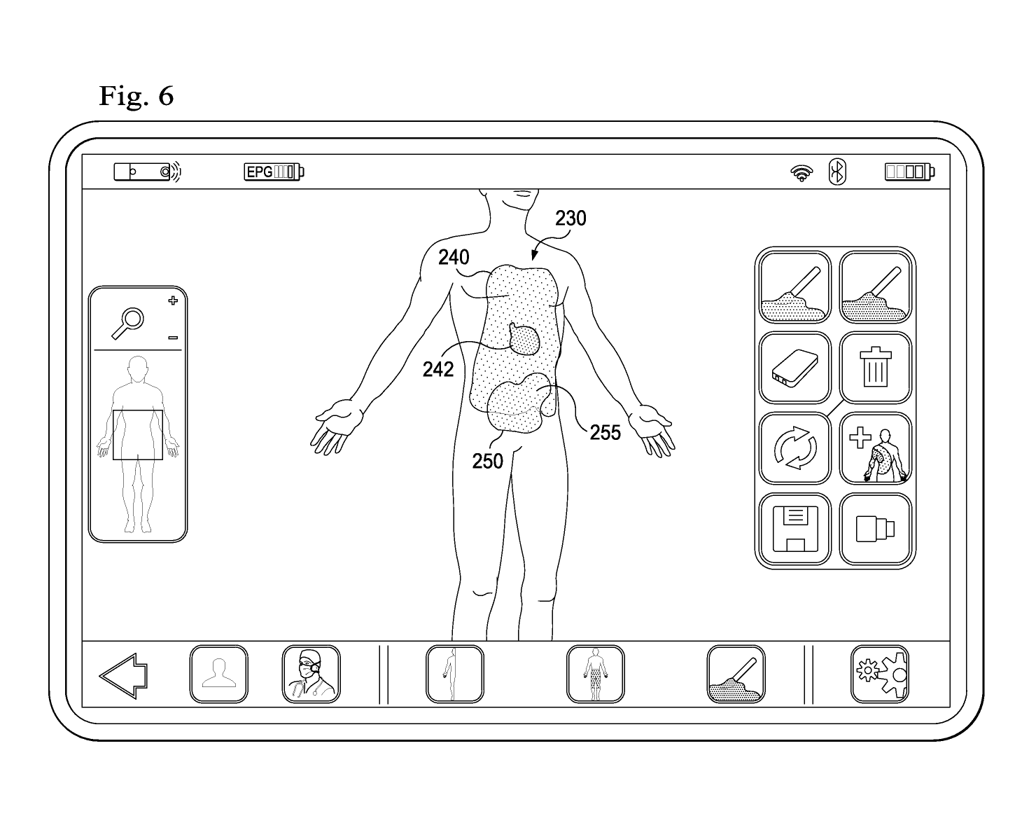

3D modeling is useful for many types of applications on a clinician programmer. One example use for 3D models on a clinician programmer is pain or stimulation mapping (or sensation mapping). In general, compared to traditional 2D images, 3D sensation maps allow a healthcare professional to see a fuller and more accurate representation of the location of the patient's pain or stimulation. An example sensation map 230 is shown in FIG. 6, which contains an example screenshot of a user interface for generating and displaying 3D sensation maps. In some embodiments, the sensation map 230 may be displayed on a screen of a programmer, for example a capacitive or resistive touch-sensitive display. In other embodiments, the user interface 100 may be displayed on a programmer and an external monitor simultaneously, for example in accordance with U.S. patent application Ser. No. 13/600,875, filed on August 31, entitled “Clinician Programming System and Method”, attorney docket 46901.11/QIG068, the disclosure of which is hereby incorporated by reference in its entirety. As such, both the healthcare provider and the patient are able to view the user interface at the same time.

The sensation map 230 is displayed on a 3D human body model in the present example. The human body model can also be moved in all directions, rotated, resized, or otherwise manipulated. In some embodiments, the human body model is customized for a specific patient. For instance, if a patient is tall (e.g., 6 feet or taller), the human body model may be created (or later resized) to be “taller” too, so as to correspond with the patient's height. As another example, if the patient is overweight or underweight, the human body model may be created (or later resized) to be wider or narrower, so as to correspond with the patient's weight. As other examples, if the patient has particularly long or short limbs, hands/feet, or a specific body build, the human body model may be created (or later resized) to correspond with these body characteristics of the patient as well. The accurate human body modeling to account for the patient specifics is useful, because it allows the implants to be proportionally correct in size. For example, a 12-contact spinal cord stimulation lead may cover 2 vertebras in a tall patient, but may cover 3 vertebras in a short patient.

The sensation map 230 can be created in response to a gesture-based input from a user. For example, as a tactile-based input, a patient can user his/her finger(s) as a simulated brush to draw or paint an area on the human body model (displayed on the clinician programmer) that corresponds to a region of pain the patient experiences. If the patient feels pain in his/her shoulder, he/she can paint a pain map on the shoulder region of the human body model. The human body model can also be rotated, so that the patient can paint the pain map in different regions of the human body model. The patient may revise the pain map to correspond as closely with the actual perceived regions of pain as possible. To facilitate the painting/drawing of the pain maps, the simulated brush may be of adjustable size. The stimulation map may be created in a similar manner, except that the stimulation map corresponds with the perceived stimulation experienced by the patient.

The sensation map is drawn on a touch-sensitive screen of the clinician programmer in the illustrated embodiment, but it is understood that alternative types of input/output devices may be used to create the sensation map. In addition, other suitable gesture based input may be used to create the sensation map, for example a gesture input that does not involve touch, but rather the motions of arms/hands/fingers, may be used. These non-touch-related gesture input may also require a camera to detect the movement of the user's arms/hands/fingers in various embodiments.

The patient may also indicate the intensity of the pain or stimulation with different colors or shading. For example, the patient may draw a region 240 as a “baseline” pain region. This region 240 may represent the body regions where the patient feels some degree of pain. The patient may also draw a region 242 within the region 242 as an “intense” or “acute” pain region. In other words, the patient may feel much more pain in the region 142 than in the rest of the region 240. The degree of the pain intensity may correspond with a color (or hue) of the region, and a variety of colors may be available to represent different degrees of pain. Thus, a pain map of the present disclosure may reveal various regions with different degrees of pain. In some embodiments, the more painful regions are represented by darker colors, and the less painful regions are represented by lighter colors. The opposite may be true in other embodiments.

Similarly, the patient may also draw a region 250 over the 3D model to indicate a region on the body where the patient experiences stimulation. Note that the pain region 240 and the stimulation region 250 may be displayed simultaneously, as shown in FIG. 6. An overlapping region 255 (an overlapping between the pain region 240 and the stimulation region 250) may also be displayed, which is helpful in helping the healthcare professional in diagnosing and treating the patient. Also, although not specifically illustrated for reasons of simplicity, it is understood that the patient may also use different shading or coloring to designate different degrees of stimulation for the stimulation region 250.

A more detailed discussion of the use of 3D modeling in sensation mapping is found in U.S. patent application Ser. No. 13/973,219 filed on Aug. 22, 2013, entitled “Method and System of Producing 2D Representations of 3D Pain and Stimulation Maps and Implant Models On a Clinician Programmer”, the disclosure of which is hereby incorporated by reference in its entirety.

Based on the discussions above, it is understood that the vertex-reduced 3D model essentially has multiple layers over it in the above example. One of the layers is the shading texture that is created from the original unreduced 3D model. Again, the application of the shading texture on the vertex-reduced 3D model makes the vertex-reduced 3D model look more like the original unreduced 3D model. Another layer is the pain map (e.g., pain region 240), which visually indicates the pain experienced by the patient. Yet another layer is the stimulation map (e.g., stimulation region 250), which visually indicates the stimulation experienced by the patient. As these various layers are applied over the vertex-reduced 3D model, they can be rotated, moved, resized, or otherwise manipulated, in sync with the vertex-reduced 3D model, on a real-time or near near-time basis. In other words, as the user interactively manipulates the vertex-reduced 3D model, the shading texture as well as the pain and stimulation maps drawn thereon will also be manipulated in the same manner near instantaneously, thereby giving the healthcare professional more freedom in visualizing the patient's conditions without encountering meaningful lag.

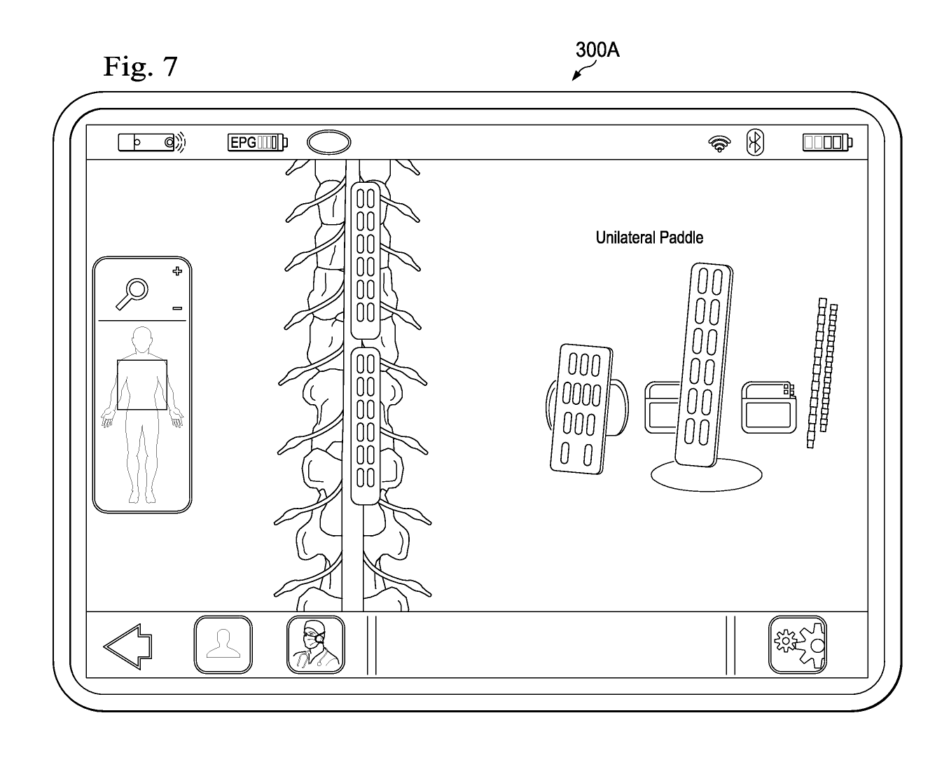

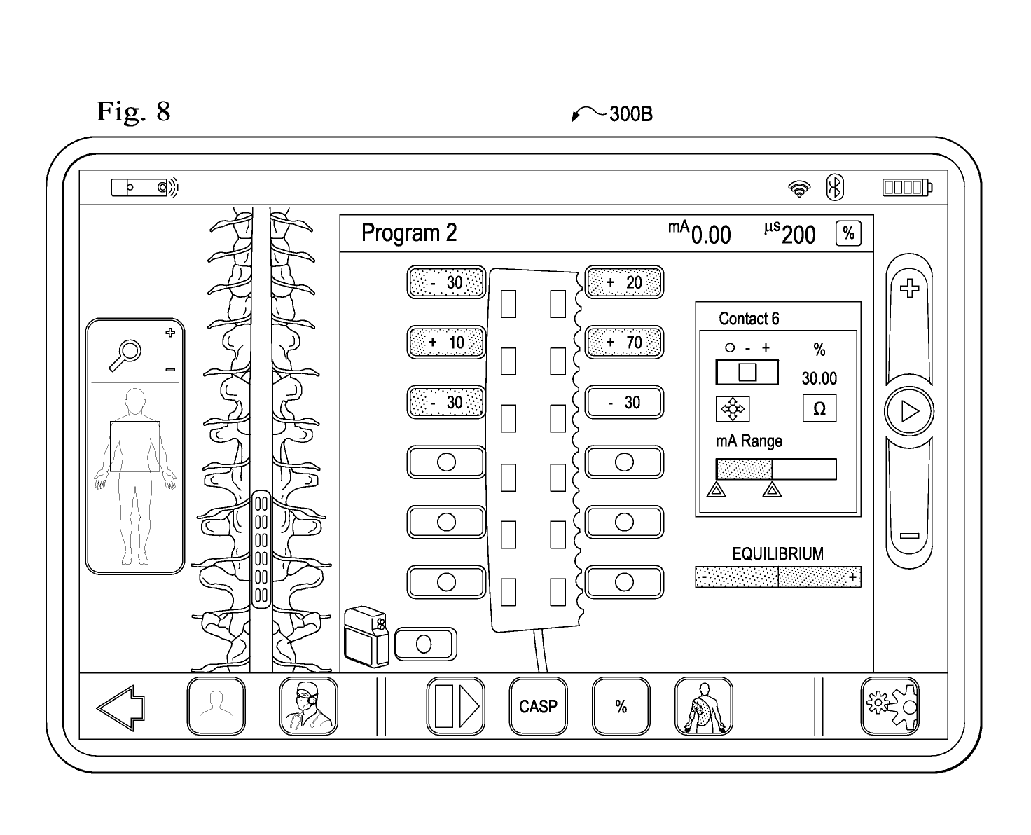

Another example use for 3D models on a clinician programmer is programming pulse parameters. An example programming interface 300 for programming pulse parameters is illustrated in FIGS. 7-8. In more detail, FIG. 7 illustrates a programming interface 300A for choosing a suitable implantable medical device (for example from a virtual carousel representation), and FIG. 8 illustrates a programming interface 300B for an example programming screen for setting the various programming parameters. Whereas traditional programming interfaces typically rely on a text-based interface to input pulse parameters such as polarity, frequency, pulse width, electrical current distribution, etc., the efficient and fluid 3D modeling allows accurate 3D models of spines and implantable medical devices to be displayed as a part of the programming interface 300. Consequently, the healthcare professional can visualize all components of the programming process, for example where to place the lead(s) in relation to the spine. Again, the 3D modeling of the present disclosure increases user satisfaction and reduces potential errors in programming pulse parameters on a clinician programmer.

A more detailed discussion of programming pulse parameters is found in U.S. patent application Ser. No. 13/601,449 filed on Aug. 31, 2012, entitled “Virtual Reality Representation of Medical Devices” to Kaula et al., attorney docket 46901.26/QIG098, and U.S. patent application Ser. No. 13/601,631 filed on Aug. 31, 2012, entitled “Programming and Virtual Reality Representation of Stimulation Parameter Groups” to Kaula et al., attorney docket 46901.27/QIG099, the disclosures of each which is hereby incorporated by reference in their entirety.

It is understood that, in some embodiments, one or more steps of the vertex reduction process discussed above may be performed by the clinician programmer or by another suitable portable electronic device, such as a patient programmer or a computer tablet. However, in other embodiments, one or more steps of the vertex reduction process may also be performed by a different computer, for example a standalone computer or computer server separate from the clinician programmer. Such computer may be communicatively coupled with the portable electronic device. For example, in some embodiments, the original unreduced 3D model may be generated by a computer, and that computer may also be used to generate the shading texture based on the original 3D model, as well as the vertex-reduced 3D model. Once the shading texture is applied to the vertex-reduced 3D model, the clinician programmer may be used to manipulate the 3D model, for example in real-time, and pain/stimulation maps may be constructed on the vertex-reduced 3D model using the clinician programmer as well.

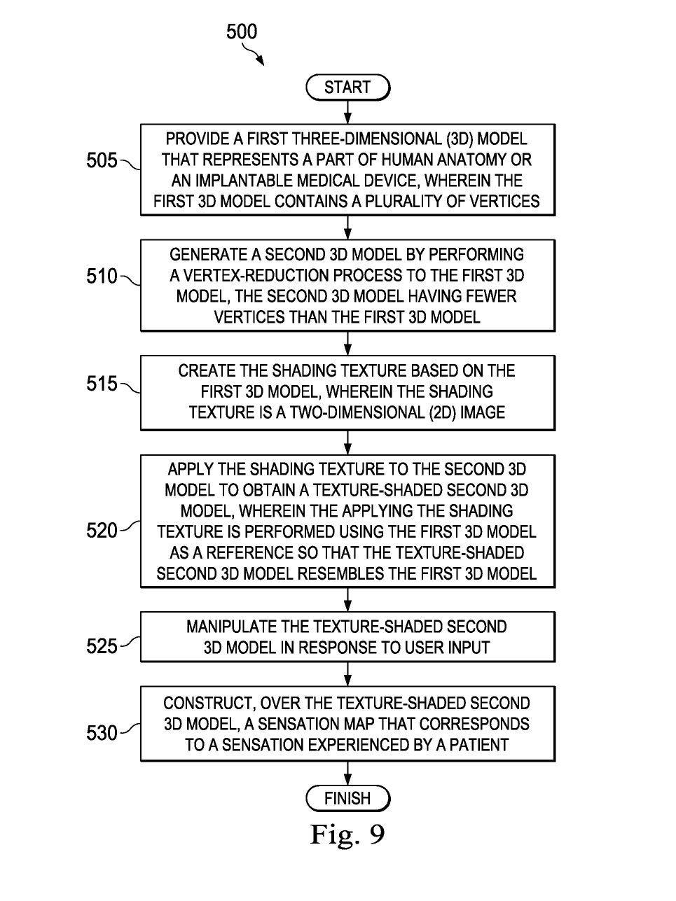

FIG. 9 is a flowchart illustrating an example method of providing 3D imaging in a medical environment. The method 500 includes a step 505, in which a first 3D model is provided. The first 3D model represents a part of human anatomy or an implantable medical device. The first 3D model contains a plurality of vertices.

The method 500 includes a step 510, in which a second 3D model is generated by performing a vertex-reduction process to the first 3D model. The second 3D model has fewer vertices than the first 3D model. In some embodiments, the vertex-reduction process comprises at least one of: an edge sliding process or a vertex merging process.

The method 500 includes a step 515, in which the shading texture is created based on the first 3D model. The shading texture is a two-dimensional (2D) image.

The method 500 includes a step 520, in which a shading texture is applied to the second 3D model to obtain a texture-shaded second 3D model. The step 520 is performed using the first 3D model as a reference so that the texture-shaded second 3D model resembles the first 3D model. In some embodiments, the shading texture contains a plurality of colors or hues that are used to create normal vectors of differing values, and wherein normal vectors are vectors that point perpendicularly to a surface.

The method 500 includes a step 525, in which the texture-shaded second 3D model is manipulated in response to user input. In some embodiments, the manipulating comprises moving, rotating, or resizing the texture-shaded second 3D model.

The method 500 includes a step 530, in which a sensation map is constructed over the texture-shaded second 3D model. The sensation map corresponds to a sensation experienced by a patient. In some embodiments, the sensation map comprises at least one of: a pain map that represents a pain sensation experienced by the patient or a stimulation map that represents a stimulation sensation experienced by the patient. In some embodiments, the sensation map comprises an overlapping of the pain map and the stimulation map. In some embodiments, the constructing the sensation map is performed in response to a gesture-based input from a user. In some embodiments, the gesture-based input includes a tactile input with respect to a touch-sensitive screen on which the 3D model is displayed.

In some embodiments, one or more of the steps 505-530 are performed by a portable electronic device, such as a clinician programmer, a patient programmer, or a computer tablet. In other embodiments, one or more of the steps 505-530 may be performed by a computer system different from the portable electronic device. The computer system may be communicatively coupled with the portable electronic device.

It is also understood that additional steps may be performed before, during, or after the steps 505-530, but these additional steps are not specifically discussed herein for reasons of simplicity.

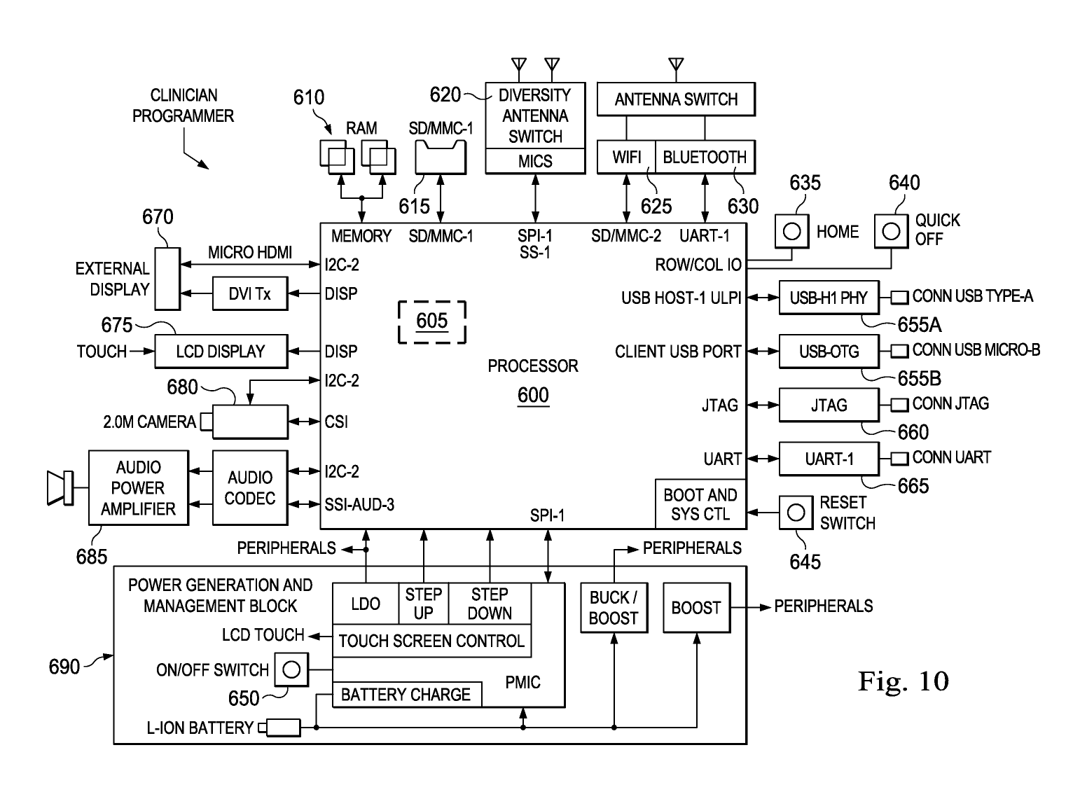

FIG. 10 shows a block diagram of one embodiment of the electronic programmer (CP) discussed herein. For example, the electronic programmer may be a clinician programmer (CP) configured to generate the vertex-reduced 3d models discussed above. It is understood, however, that alternative embodiments of the electronic programmer may be used to perform these representations as well.

The CP includes a printed circuit board (“PCB”) that is populated with a plurality of electrical and electronic components that provide power, operational control, and protection to the CP. With reference to FIG. 10, the CP includes a processor 600. The processor 600 controls the CP. In one construction, the processor 600 is an applications processor model i.MX515 available from Free scale Semiconductor®. More specifically, the i.MX515 applications processor has internal instruction and data caches, multimedia capabilities, external memory interfacing, and interfacing flexibility. Further information regarding the i.MX515 applications processor can be found in, for example, the “IMX51CEC, Rev. 4” data sheet dated August 2010 and published by Free scale Semiconductor® at www.freescale.com. The content of the data sheet is incorporated herein by reference. Of course, other processing units, such as other microprocessors, microcontrollers, digital signal processors, etc., can be used in place of the processor 600.

The CP includes memory, which can be internal to the processor 600 (e.g., memory 605), external to the processor 600 (e.g., memory 610), or a combination of both. Exemplary memory include a read-only memory (“ROM”), a random access memory (“RAM”), an electrically erasable programmable read-only memory (“EEPROM”), a flash memory, a hard disk, or another suitable magnetic, optical, physical, or electronic memory device. The processor 600 executes software that is capable of being stored in the RAM (e.g., during execution), the ROM (e.g., on a generally permanent basis), or another non-transitory computer readable medium such as another memory or a disc. The CP also includes input/output (“I/O”) systems that include routines for transferring information between components within the processor 600 and other components of the CP or external to the CP.

Software included in the implementation of the CP is stored in the memory 605 of the processor 600, RAM 610, ROM 615, or external to the CP. The software includes, for example, firmware, one or more applications, program data, one or more program modules, and other executable instructions. The processor 600 is configured to retrieve from memory and execute, among other things, instructions related to the control processes and methods described below for the CP.

One memory shown in FIG. 10 is memory 610, which may be a double data rate (DDR2) synchronous dynamic random access memory (SDRAM) for storing data relating to and captured during the operation of the CP. In addition, a secure digital (SD) multimedia card (MMC) may be coupled to the CP for transferring data from the CP to the memory card via slot 615. Of course, other types of data storage devices may be used in place of the data storage devices shown in FIG. 10.

The CP includes multiple bi-directional radio communication capabilities. Specific wireless portions included with the CP are a Medical Implant Communication Service (MICS) bi-directional radio communication portion 620, a Wi-Fi bi-directional radio communication portion 625, and a Bluetooth bi-directional radio communication portion 630. The MICS portion 620 includes a MICS communication interface, an antenna switch, and a related antenna, all of which allows wireless communication using the MICS specification. The Wi-Fi portion 625 and Bluetooth portion 630 include a Wi-Fi communication interface, a Bluetooth communication interface, an antenna switch, and a related antenna all of which allows wireless communication following the Wi-Fi Alliance standard and Bluetooth Special Interest Group standard. Of course, other wireless local area network (WLAN) standards and wireless personal area networks (WPAN) standards can be used with the CP.

The CP includes three hard buttons: a “home” button 635 for returning the CP to a home screen for the device, a “quick off” button 640 for quickly deactivating stimulation IPG, and a “reset” button 645 for rebooting the CP. The CP also includes an “ON/OFF” switch 650, which is part of the power generation and management block (discussed below).

The CP includes multiple communication portions for wired communication. Exemplary circuitry and ports for receiving a wired connector include a portion and related port for supporting universal serial bus (USB) connectivity 655, including a Type A port and a Micro-B port; a portion and related port for supporting Joint Test Action Group (JTAG) connectivity 660, and a portion and related port for supporting universal asynchronous receiver/transmitter (UART) connectivity 665. Of course, other wired communication standards and connectivity can be used with or in place of the types shown in FIG. 10.

Another device connectable to the CP, and therefore supported by the CP, is an external display. The connection to the external display can be made via a micro High-Definition Multimedia Interface (HDMI) 670, which provides a compact audio/video interface for transmitting uncompressed digital data to the external display. The use of the HDMI connection 670 allows the CP to transmit video (and audio) communication to an external display. This may be beneficial in situations where others (e.g., the surgeon) may want to view the information being viewed by the healthcare professional. The surgeon typically has no visual access to the CP in the operating room unless an external screen is provided. The HDMI connection 670 allows the surgeon to view information from the CP, thereby allowing greater communication between the clinician and the surgeon. For a specific example, the HDMI connection 670 can broadcast a high definition television signal that allows the surgeon to view the same information that is shown on the LCD (discussed below) of the CP.

The CP includes a touch screen I/O device 675 for providing a user interface with the clinician. The touch screen display 675 can be a liquid crystal display (LCD) having a resistive, capacitive, or similar touch-screen technology. It is envisioned that multitouch capabilities can be used with the touch screen display 675 depending on the type of technology used.

The CP includes a camera 680 allowing the device to take pictures or video. The resulting image files can be used to document a procedure or an aspect of the procedure. Other devices can be coupled to the CP to provide further information, such as scanners or RFID detection. Similarly, the CP includes an audio portion 685 having an audio codec circuit, audio power amplifier, and related speaker for providing audio communication to the user, such as the clinician or the surgeon.

The CP further includes a power generation and management block 690. The power block 690 has a power source (e.g., a lithium-ion battery) and a power supply for providing multiple power voltages to the processor, LCD touch screen, and peripherals.

In one embodiment, the CP is a handheld computing tablet with touch screen capabilities. The tablet is a portable personal computer with a touch screen, which is typically the primary input device. However, an external keyboard or mouse can be attached to the CP. The tablet allows for mobile functionality not associated with even typical laptop personal computers. The hardware may include a Graphical Processing Unit (GPU) in order to speed up the user experience. An Ethernet port (not shown in FIG. 10) may also be included for data transfer.

It is understood that a patient programmer may be implemented in a similar manner as the clinician programmer shown in FIG. 10.

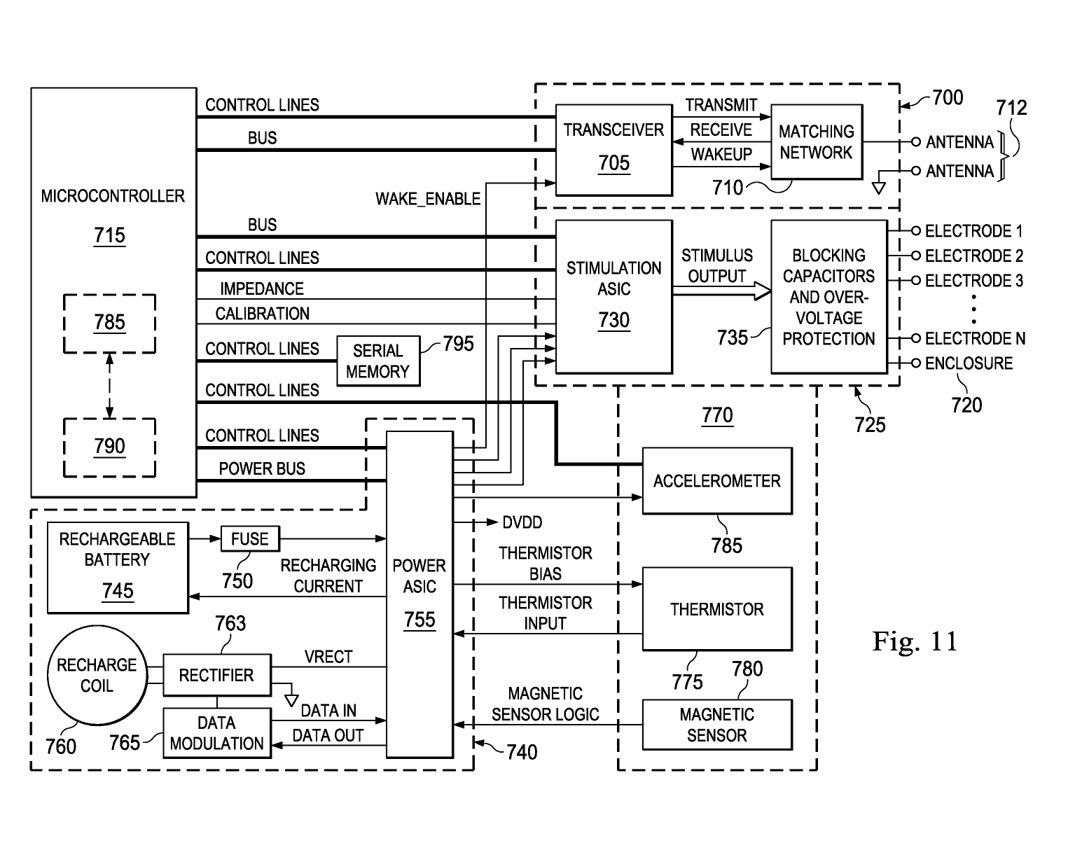

FIG. 11 shows a block diagram of one embodiment of an implantable medical device. In the embodiment shown in FIG. 11, the implantable medical device includes an implantable pulse generator (IPG). The IPG includes a printed circuit board (“PCB”) that is populated with a plurality of electrical and electronic components that provide power, operational control, and protection to the IPG. With reference to FIG. 11, the IPG includes a communication portion 700 having a transceiver 705, a matching network 710, and antenna 712. The communication portion 700 receives power from a power ASIC (discussed below), and communicates information to/from the microcontroller 715 and a device (e.g., the CP) external to the IPG. For example, the IPG can provide bi-direction radio communication capabilities, including Medical Implant Communication Service (MICS) bi-direction radio communication following the MICS specification.

The IPG provides stimuli to electrodes of an implanted medical electrical lead (not illustrated herein). As shown in FIG. 11, N electrodes are connected to the IPG. In addition, the enclosure or housing 720 of the IPG can act as an electrode. The stimuli are provided by a stimulation portion 225 in response to commands from the microcontroller 215. The stimulation portion 725 includes a stimulation application specific integrated circuit (ASIC) 730 and circuitry including blocking capacitors and an over-voltage protection circuit. As is well known, an ASIC is an integrated circuit customized for a particular use, rather than for general purpose use. ASICs often include processors, memory blocks including ROM, RAM, EEPROM, FLASH, etc. The stimulation ASIC 730 can include a processor, memory, and firmware for storing preset pulses and protocols that can be selected via the microcontroller 715. The providing of the pulses to the electrodes is controlled through the use of a waveform generator and amplitude multiplier of the stimulation ASIC 730, and the blocking capacitors and overvoltage protection circuitry 735 of the stimulation portion 725, as is known in the art. The stimulation portion 725 of the IPG receives power from the power ASIC (discussed below). The stimulation ASIC 730 also provides signals to the microcontroller 715. More specifically, the stimulation ASIC 730 can provide impedance values for the channels associated with the electrodes, and also communicate calibration information with the microcontroller 715 during calibration of the IPG.

The IPG also includes a power supply portion 740. The power supply portion includes a rechargeable battery 745, fuse 750, power ASIC 755, recharge coil 760, rectifier 763 and data modulation circuit 765. The rechargeable battery 745 provides a power source for the power supply portion 740. The recharge coil 760 receives a wireless signal from the PPC. The wireless signal includes an energy that is converted and conditioned to a power signal by the rectifier 763. The power signal is provided to the rechargeable battery 745 via the power ASIC 755. The power ASIC 755 manages the power for the IPG. The power ASIC 755 provides one or more voltages to the other electrical and electronic circuits of the IPG. The data modulation circuit 765 controls the charging process.

The IPG also includes a magnetic sensor 780. The magnetic sensor 780 provides a “hard” switch upon sensing a magnet for a defined period. The signal from the magnetic sensor 780 can provide an override for the IPG if a fault is occurring with the IPG and is not responding to other controllers.

The IPG is shown in FIG. 11 as having a microcontroller 715. Generally speaking, the microcontroller 715 is a controller for controlling the IPG. The microcontroller 715 includes a suitable programmable portion 785 (e.g., a microprocessor or a digital signal processor), a memory 790, and a bus or other communication lines. An exemplary microcontroller capable of being used with the IPG is a model MSP430 ultra-low power, mixed signal processor by Texas Instruments. More specifically, the MSP430 mixed signal processor has internal RAM and flash memories, an internal clock, and peripheral interface capabilities. Further information regarding the MSP 430 mixed signal processor can be found in, for example, the “MSP430G2x32, MSP430G2x02 MIXED SIGNAL MICROCONTROLLER” data sheet; dated December 2010, published by Texas Instruments at www.ti.com; the content of the data sheet being incorporated herein by reference.

The IPG includes memory, which can be internal to the control device (such as memory 790), external to the control device (such as serial memory 795), or a combination of both. Exemplary memory include a read-only memory (“ROM”), a random access memory (“RAM”), an electrically erasable programmable read-only memory (“EEPROM”), a flash memory, a hard disk, or another suitable magnetic, optical, physical, or electronic memory device. The programmable portion 785 executes software that is capable of being stored in the RAM (e.g., during execution), the ROM (e.g., on a generally permanent basis), or another non-transitory computer readable medium such as another memory or a disc.

Software included in the implementation of the IPG is stored in the memory 790. The software includes, for example, firmware, one or more applications, program data, one or more program modules, and other executable instructions. The programmable portion 785 is configured to retrieve from memory and execute, among other things, instructions related to the control processes and methods described below for the IPG. For example, the programmable portion 285 is configured to execute instructions retrieved from the memory 790 for sweeping the electrodes in response to a signal from the CP.

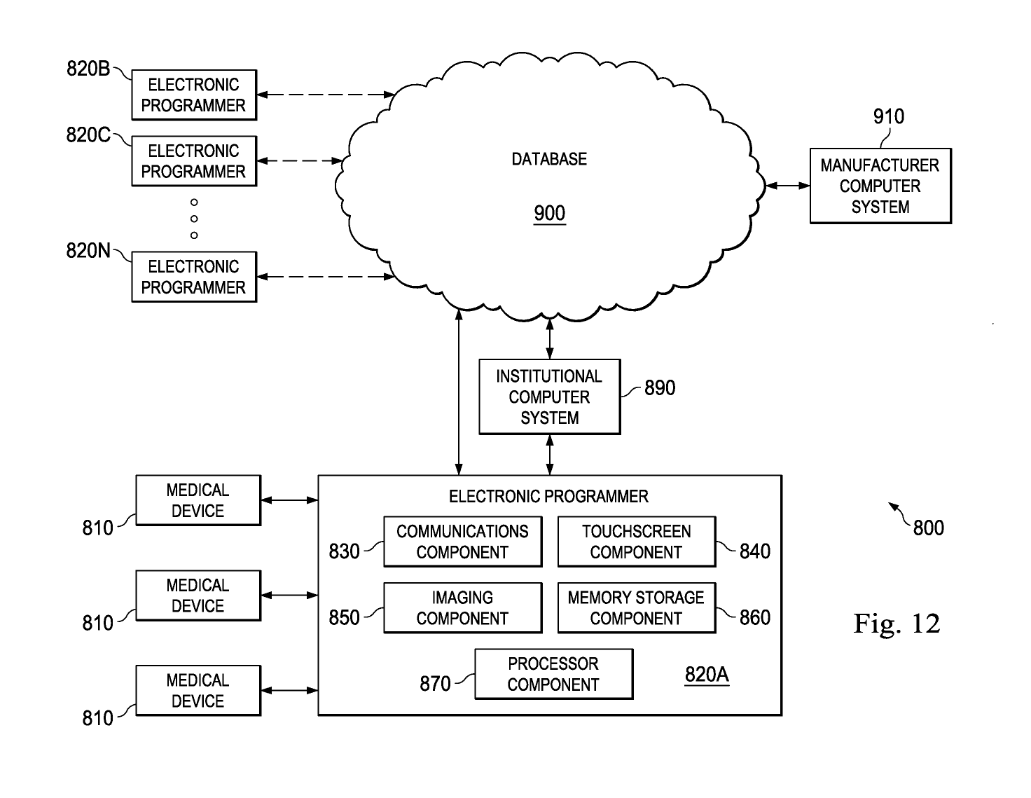

Referring now to FIG. 12, a simplified block diagram of a medical infrastructure 800 (which may also be considered a medical system) is illustrated according to various aspects of the present disclosure. The medical infrastructure 800 includes a plurality of medical devices 810. These medical devices 810 may each be a programmable medical device (or parts thereof) that can deliver a medical therapy to a patient. In some embodiments, the medical devices 810 may include a device of the neurostimulator system discussed above with reference to FIG. 1. For example, the medical devices 810 may be a pulse generator (e.g., the IPG discussed above with reference to FIG. 11), an implantable lead, a charger, or portions thereof. It is understood that each of the medical devices 810 may be a different type of medical device. In other words, the medical devices 810 need not be the same type of medical device.

The medical infrastructure 800 also includes a plurality of electronic programmers 820. For sake of illustration, one of these electronic programmers 820A is illustrated in more detail and discussed in detail below. Nevertheless, it is understood that each of the electronic programmers 820 may be implemented similar to the electronic programmer 820A.

In some embodiments, the electronic programmer 820A may be a clinician programmer, for example the clinician programmer discussed above with reference to FIG. 10. In other embodiments, the electronic programmer 820A may be a patient programmer or another similar programmer. In further embodiments, it is understood that the electronic programmer may be a tablet computer. In any case, the electronic programmer 820A is configured to program the stimulation parameters of the medical devices 810 so that a desired medical therapy can be delivered to a patient.

The electronic programmer 820A contains a communications component 830 that is configured to conduct electronic communications with external devices. For example, the communications device 830 may include a transceiver. The transceiver contains various electronic circuitry components configured to conduct telecommunications with one or more external devices. The electronic circuitry components allow the transceiver to conduct telecommunications in one or more of the wired or wireless telecommunications protocols, including communications protocols such as IEEE 802.11 (Wi-Fi), IEEE 802.15 (Bluetooth), GSM, CDMA, LTE, WIMAX, DLNA, HDMI, Medical Implant Communication Service (MICS), etc. In some embodiments, the transceiver includes antennas, filters, switches, various kinds of amplifiers such as low-noise amplifiers or power amplifiers, digital-to-analog (DAC) converters, analog-to-digital (ADC) converters, mixers, multiplexers and demultiplexers, oscillators, and/or phase-locked loops (PLLs). Some of these electronic circuitry components may be integrated into a single discrete device or an integrated circuit (IC) chip.

The electronic programmer 820A contains a touchscreen component 840. The touchscreen component 840 may display a touch-sensitive graphical user interface that is responsive to gesture-based user interactions. The touch-sensitive graphical user interface may detect a touch or a movement of a user's finger(s) on the touchscreen and interpret these user actions accordingly to perform appropriate tasks. The graphical user interface may also utilize a virtual keyboard to receive user input. In some embodiments, the touch-sensitive screen may be a capacitive touchscreen. In other embodiments, the touch-sensitive screen may be a resistive touchscreen.

It is understood that the electronic programmer 820A may optionally include additional user input/output components that work in conjunction with the touchscreen component 840 to carry out communications with a user. For example, these additional user input/output components may include physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, etc.

The electronic programmer 820A contains an imaging component 850. The imaging component 850 is configured to capture an image of a target device via a scan. For example, the imaging component 850 may be a camera in some embodiments. The camera may be integrated into the electronic programmer 820A. The camera can be used to take a picture of a medical device, or scan a visual code of the medical device, for example its barcode or Quick Response (QR) code.

The electronic programmer contains a memory storage component 860. The memory storage component 860 may include system memory, (e.g., RAM), static storage 608 (e.g., ROM), or a disk drive (e.g., magnetic or optical), or any other suitable types of computer readable storage media. For example, some common types of computer readable media may include floppy disk, flexible disk, hard disk, magnetic tape, any other magnetic medium, CD-ROM, any other optical medium, RAM, PROM, EPROM, FLASH-EPROM, any other memory chip or cartridge, or any other medium from which a computer is adapted to read. The computer readable medium may include, but is not limited to, non-volatile media and volatile media. The computer readable medium is tangible, concrete, and non-transitory. Logic (for example in the form of computer software code or computer instructions) may be encoded in such computer readable medium. In some embodiments, the memory storage component 860 (or a portion thereof) may be configured as a local database capable of storing electronic records of medical devices and/or their associated patients.

The electronic programmer contains a processor component 870. The processor component 870 may include a central processing unit (CPU), a graphics processing unit (GPU) a micro-controller, a digital signal processor (DSP), or another suitable electronic processor capable of handling and executing instructions. In various embodiments, the processor component 870 may be implemented using various digital circuit blocks (including logic gates such as AND, OR, NAND, NOR, XOR gates, etc.) along with certain software code. In some embodiments, the processor component 870 may execute one or more sequences computer instructions contained in the memory storage component 860 to perform certain tasks.

It is understood that hard-wired circuitry may be used in place of (or in combination with) software instructions to implement various aspects of the present disclosure. Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

It is also understood that the electronic programmer 820A is not necessarily limited to the components 830-870 discussed above, but it may further include additional components that are used to carry out the programming tasks. These additional components are not discussed herein for reasons of simplicity. It is also understood that the medical infrastructure 800 may include a plurality of electronic programmers similar to the electronic programmer 820A discussed herein, but they are not illustrated in FIG. 12 for reasons of simplicity.

The medical infrastructure 800 also includes an institutional computer system 890. The institutional computer system 890 is coupled to the electronic programmer 820A. In some embodiments, the institutional computer system 890 is a computer system of a healthcare institution, for example a hospital. The institutional computer system 890 may include one or more computer servers and/or client terminals that may each include the necessary computer hardware and software for conducting electronic communications and performing programmed tasks. In various embodiments, the institutional computer system 890 may include communications devices (e.g., transceivers), user input/output devices, memory storage devices, and computer processor devices that may share similar properties with the various components 830-870 of the electronic programmer 820A discussed above. For example, the institutional computer system 890 may include computer servers that are capable of electronically communicating with the electronic programmer 820A through the MICS protocol or another suitable networking protocol.

The medical infrastructure 800 includes a database 900. In various embodiments, the database 900 is a remote database—that is, located remotely to the institutional computer system 890 and/or the electronic programmer 820A. The database 900 is electronically or communicatively (for example through the Internet) coupled to the institutional computer system 890 and/or the electronic programmer. In some embodiments, the database 900, the institutional computer system 890, and the electronic programmer 820A are parts of a cloud-based architecture. In that regard, the database 900 may include cloud-based resources such as mass storage computer servers with adequate memory resources to handle requests from a variety of clients. The institutional computer system 890 and the electronic programmer 820A (or their respective users) may both be considered clients of the database 900. In certain embodiments, the functionality between the cloud-based resources and its clients may be divided up in any appropriate manner. For example, the electronic programmer 820A may perform basic input/output interactions with a user, but a majority of the processing and caching may be performed by the cloud-based resources in the database 900. However, other divisions of responsibility are also possible in various embodiments.

According to the various aspects of the present disclosure, the sensation maps may be uploaded from the electronic programmer 820A to the database 900. The sensation maps saved in the database 900 may thereafter be downloaded by any of the other electronic programmers 820B-820N communicatively coupled to it, assuming the user of these programmers has the right login permissions. For example, after the 2D sensation map is generated by the electronic programmer 820A and uploaded to the database 900. That 2D sensation map can then be downloaded by the electronic programmer 820B, which can use the downloaded 2D sensation map to reconstruct or recreate a 3D sensation map. In this manner, a less data-intensive 2D sensation map may be derived from a data-heavy 3D sensation map, sent to a different programmer through the database, and then be used to reconstruct the 3D sensation map.

The database 900 may also include a manufacturer's database in some embodiments. It may be configured to manage an electronic medical device inventory, monitor manufacturing of medical devices, control shipping of medical devices, and communicate with existing or potential buyers (such as a healthcare institution). For example, communication with the buyer may include buying and usage history of medical devices and creation of purchase orders. A message can be automatically generated when a client (for example a hospital) is projected to run out of equipment, based on the medical device usage trend analysis done by the database. According to various aspects of the present disclosure, the database 900 is able to provide these functionalities at least in part via communication with the electronic programmer 820A and in response to the data sent by the electronic programmer 820A. These functionalities of the database 900 and its communications with the electronic programmer 820A will be discussed in greater detail later.

The medical infrastructure 800 further includes a manufacturer computer system 910. The manufacturer computer system 910 is also electronically or communicatively (for example through the Internet) coupled to the database 900. Hence, the manufacturer computer system 910 may also be considered a part of the cloud architecture. The computer system 910 is a computer system of medical device manufacturer, for example a manufacturer of the medical devices 810 and/or the electronic programmer 820A.

In various embodiments, the manufacturer computer system 910 may include one or more computer servers and/or client terminals that each includes the necessary computer hardware and software for conducting electronic communications and performing programmed tasks. In various embodiments, the manufacturer computer system 910 may include communications devices (e.g., transceivers), user input/output devices, memory storage devices, and computer processor devices that may share similar properties with the various components 830-870 of the electronic programmer 820A discussed above. Since both the manufacturer computer system 910 and the electronic programmer 820A are coupled to the database 900, the manufacturer computer system 910 and the electronic programmer 820A can conduct electronic communication with each other.

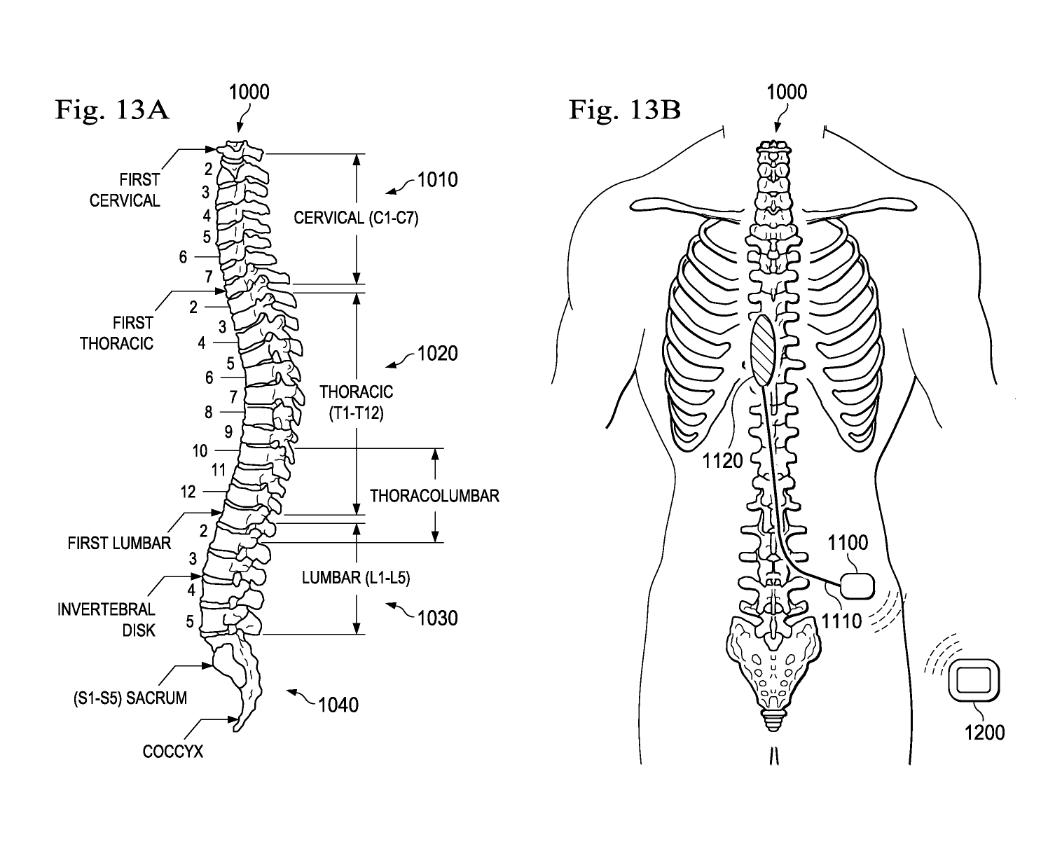

FIG. 13A is a side view of a spine 1000, and FIG. 13B is a posterior view of the spine 1000. The spine 1000 includes a cervical region 1010, a thoracic region 1020, a lumbar region 1030, and a sacrococcygeal region 1040. The cervical region 1010 includes the top 7 vertebrae, which may be designated with C1-C7. The thoracic region 1020 includes the next 12 vertebrae below the cervical region 1010, which may be designated with T1-T12. The lumbar region 1030 includes the final 5 “true” vertebrae, which may be designated with L1-L5. The sacrococcygeal region 1040 includes 9 fused vertebrae that make up the sacrum and the coccyx. The fused vertebrae of the sacrum may be designated with S1-S5.

Neural tissue (not illustrated for the sake of simplicity) branch off from the spinal cord through spaces between the vertebrae. The neural tissue can be individually and selectively stimulated in accordance with various aspects of the present disclosure. For example, referring to FIG. 13B, an IPG device 1100 is implanted inside the body. The IPG device 1100 may include a neurostimulator device. A conductive lead 1110 is electrically coupled to the circuitry inside the IPG device 1100. The conductive lead 1110 may be removably coupled to the IPG device 1100 through a connector, for example. A distal end of the conductive lead 1110 is attached to one or more electrodes 1120. The electrodes 1120 are implanted adjacent to a desired nerve tissue in the thoracic region 1020. Using well-established and known techniques in the art, the distal end of the lead 1110 with its accompanying electrodes may be positioned along or near the epidural space of the spinal cord. It is understood that although only one conductive lead 1110 is shown herein for the sake of simplicity, more than one conductive lead 1110 and corresponding electrodes 1120 may be implanted and connected to the IPG device 1100.

The electrodes 1120 deliver current drawn from the current sources in the IPG device 1100, therefore generating an electric field near the neural tissue. The electric field stimulates the neural tissue to accomplish its intended functions. For example, the neural stimulation may alleviate pain in an embodiment. In other embodiments, a stimulator may be placed in different locations throughout the body and may be programmed to address a variety of problems, including for example but without limitation; prevention or reduction of epileptic seizures, weight control or regulation of heart beats.

It is understood that the IPG device 1100, the lead 1110, and the electrodes 1120 may be implanted completely inside the body, may be positioned completely outside the body or may have only one or more components implanted within the body while other components remain outside the body. When they are implanted inside the body, the implant location may be adjusted (e.g., anywhere along the spine 1000) to deliver the intended therapeutic effects of spinal cord electrical stimulation in a desired region of the spine. Furthermore, it is understood that the IPG device 1100 may be controlled by a patient programmer or a clinician programmer 1200, the implementation of which may be similar to the clinician programmer shown in FIG. 10.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An electronic device for providing three-dimensional imaging in a medical environment, the electronic device comprising:
a memory storage component configured to store programming code; and
a computer processor configured to execute the programming code to perform the following tasks:
providing a first three-dimensional (3D) model that represents a part of human anatomy or an implantable medical device, wherein the first 3D model contains a plurality of vertices;
generating a second 3D model by performing a vertex-reduction process to the first 3D model, the second 3D model having fewer vertices than the first 3D model; and
applying a shading texture to the second 3D model to obtain a texture-shaded second 3D model, wherein the applying the shading texture is performed using the first 3D model as a reference so that the texture-shaded second 3D model resembles the first 3D model.

2. The electronic device of claim 1, wherein the programming code is executed to further perform the following task: creating the shading texture based on the first 3D model, wherein the shading texture is a two-dimensional (2D) image.

3. The electronic device of claim 1, wherein the shading texture contains a plurality of colors or hues that are used to create normal vectors of differing values, and wherein normal vectors are vectors that point perpendicularly to a surface.

4. The electronic device of claim 1, wherein the programming code is executed to further perform the following task: manipulating, in real-time, the texture-shaded second 3D model in response to an input from a user.

5. The electronic device of claim 4, wherein the manipulating comprises moving, rotating, or resizing the texture-shaded second 3D model.

6. The electronic device of claim 1, wherein the programming code is executed to further perform the following task: constructing, over the texture-shaded second 3D model, a sensation map that corresponds to a sensation experienced by a patient.

7. The electronic device of claim 6, wherein the sensation map comprises at least one of: a pain map that represents a pain sensation experienced by the patient or a stimulation map that represents a stimulation sensation experienced by the patient.

8. The electronic device of claim 7, wherein the sensation map comprises an overlapping of the pain map and the stimulation map.

9. The electronic device of claim 6, wherein the constructing the sensation map is performed in response to a gesture-based input from a user.

10. The electronic device of claim 1, wherein the vertex-reduction process comprises at least one of: an edge sliding process or a vertex merging process.

11. The electronic device of claim 1, wherein the electronic device is one of: a clinician programmer, a patient programmer, and a computer tablet, and wherein the electronic device is portable and is configured to communicate with external devices according to a wired or wireless communications protocol.

12. The electronic device of claim 1, further comprising a communications interface configured to receive an input from a user and display a visual output to the user.

13. The electronic device of claim 12, wherein the communications interface comprises a touch-screen display responsive to a touch input from the user.

14. A medical system, comprising:
one or more medical devices configurable to deliver a medical therapy to a patient; and
an electronic device configured to provide three-dimensional (3D) imaging in a medical environment via a touch-sensitive visual user interface, wherein the electronic device includes a non-transitory computer readable medium comprising executable instructions that when executed by a processor, causes the processor to perform the steps of:
providing a first 3D model that represents a part of human anatomy or an implantable medical device, wherein the first 3D model contains a plurality of vertices;
generating a second 3D model by performing a vertex-reduction process to the first 3D model, the second 3D model having fewer vertices than the first 3D model; and
applying a shading texture to the second 3D model to obtain a texture-shaded second 3D model, wherein the applying the shading texture is performed using the first 3D model as a reference so that the texture-shaded second 3D model resembles the first 3D model.

15. The medical system of claim 14, wherein the executable instructions cause the processor to further perform a step of: creating the shading texture based on the first 3D model, wherein the shading texture is a two-dimensional (2D) image.

16. The medical system of claim 14, wherein the shading texture contains a plurality of colors or hues that are used to create normal vectors of differing values, and wherein normal vectors are vectors that point perpendicularly to a surface.

17. The medical system of claim 14, wherein the executable instructions cause the processor to further perform a step of: manipulating, in real-time, the texture-shaded second 3D model in response to user input.

18. The medical system of claim 17, wherein the manipulating comprises moving, rotating, or resizing the texture-shaded second 3D model.

19. The medical system of claim 14, wherein the executable instructions cause the processor to further perform a step of: constructing, over the texture-shaded second 3D model, a sensation map that corresponds to a sensation experienced by a patient.

20. The medical system of claim 19, wherein the sensation map comprises at least one of: a pain map that represents a pain sensation experienced by the patient or a stimulation map that represents a stimulation sensation experienced by the patient.

21. The medical system of claim 20, wherein the sensation map comprises an overlapping of the pain map and the stimulation map.

22. The medical system of claim 19, wherein the constructing the sensation map is performed in response to a gesture-based input from a user.

23. The medical system of claim 22, wherein the gesture-based input includes a tactile input with respect to a touch-sensitive screen on which the 3D model is displayed.

24. The medical system of claim 14, wherein the vertex-reduction process comprises at least one of: an edge sliding process or a vertex merging process.

25. The medical system of claim 14, wherein:
the one or more medical devices comprise: pulse generators and leads; and
the electronic device comprises one of: a clinician programmer, a patient programmer, and a computer tablet.

26. A method of providing three-dimensional (3D) imaging in a medical environment, the method comprising:
providing a first 3D model that represents a part of human anatomy or an implantable medical device, wherein the first 3D model contains a plurality of vertices;
generating a second 3D model by performing a vertex-reduction process to the first 3D model, the second 3D model having fewer vertices than the first 3D model; and
applying a shading texture to the second 3D model to obtain a texture-shaded second 3D model, wherein the applying the shading texture is performed using the first 3D model as a reference so that the texture-shaded second 3D model resembles the first 3D model.

27. The method of claim 26, further comprising: creating the shading texture based on the first 3D model, wherein the shading texture is a two-dimensional (2D) image.

28. The method of claim 26, wherein the shading texture contains a plurality of colors or hues that are used to create normal vectors of differing values, and wherein normal vectors are vectors that point perpendicularly to a surface.

29. The method of claim 26, further comprising: manipulating, in real-time, the texture-shaded second 3D model in response to user input.

30. The method of claim 29, wherein the manipulating comprises moving, rotating, or resizing the texture-shaded second 3D model.

31. The method of claim 26, further comprising: constructing, over the texture-shaded second 3D model, a sensation map that corresponds to a sensation experienced by a patient.

32. The method of claim 31, wherein the sensation map comprises at least one of: a pain map that represents a pain sensation experienced by the patient or a stimulation map that represents a stimulation sensation experienced by the patient.

33. The method of claim 32, wherein the sensation map comprises an overlapping of the pain map and the stimulation map.

34. The method of claim 31, wherein the constructing the sensation map is performed in response to a gesture-based input from a user.

35. The method of claim 34, wherein the gesture-based input includes a tactile input with respect to a touch-sensitive screen on which the 3D model is displayed.

36. The method of claim 26, wherein the vertex-reduction process comprises at least one of: an edge sliding process or a vertex merging process.

37. A non-transitory computer readable medium comprising executable instructions that when executed by a processor, causes the processor to perform the steps of:
providing a first three-dimensional (3D) model that represents a part of human anatomy or an implantable medical device, wherein the first 3D model contains a plurality of vertices;
generating a second 3D model by performing a vertex-reduction process to the first 3D model, the second 3D model having fewer vertices than the first 3D model; and
applying a shading texture to the second 3D model to obtain a texture-shaded second 3D model, wherein the applying the shading texture is performed using the first 3D model as a reference so that the texture-shaded second 3D model resembles the first 3D model.

38. The non-transitory computer readable medium of claim 37, wherein the executable instructions cause the processor to further perform a step of: creating the shading texture based on the first 3D model, wherein the shading texture is a two-dimensional (2D) image.

39. The non-transitory computer readable medium of claim 37, wherein the shading texture contains a plurality of colors or hues that are used to create normal vectors of differing values, and wherein normal vectors are vectors that point perpendicularly to a surface.

40. The non-transitory computer readable medium of claim 37, wherein the executable instructions cause the processor to further perform a step of: manipulating, in real-time, the texture-shaded second 3D model in response to user input.

41. The non-transitory computer readable medium of claim 40, wherein the manipulating comprises moving, rotating, or resizing the texture-shaded second 3D model.

42. The non-transitory computer readable medium of claim 37, wherein the executable instructions cause the processor to further perform a step of: constructing, over the texture-shaded second 3D model, a sensation map that corresponds to a sensation experienced by a patient.

43. The non-transitory computer readable medium of claim 42, wherein the sensation map comprises at least one of: a pain map that represents a pain sensation experienced by the patient or a stimulation map that represents a stimulation sensation experienced by the patient.

44. The non-transitory computer readable medium of claim 43, wherein the sensation map comprises an overlapping of the pain map and the stimulation map.

45. The non-transitory computer readable medium of claim 42, wherein the constructing the sensation map is performed in response to a gesture-based input from a user.

46. The non-transitory computer readable medium of claim 45, wherein the gesture-based input includes a tactile input with respect to a touch-sensitive screen on which the 3D model is displayed.

47. The non-transitory computer readable medium of claim 37, wherein the vertex-reduction process comprises at least one of: an edge sliding process or a vertex merging process.
